(19) United States
(12) Patent Application Publication
(10) Pub. No.: US 2026/0066598 A1
(43) Pub. Date: Mar. 5, 2026

(54) MODULE CONNECTOR ARRANGEMENT AND METHOD FOR FIXING CONTACT BETWEEN TWO BUSBAR ENDS

(71) Applicant: AUDI AG, lngolstadt (DE)

(72) Inventors: Carsten LORENZ, Reichertshofen (DE); Eduard MAIN, Buxheim (DE)

(73) Assignee: AUDI AG, lngolstadt (DE)

(21) Appl. No.: 19/299,676

(22) Filed: Aug. 14, 2025

(30) Foreign Application Priority Data
Sep. 3, 2024 (DE) 102024125124.7

(51) Int. Cl. H01R 25/16; H01M 50/503; H01M 50/507; H01M 50/517; H01R 13/621; H01R 13/629; H01R 43/26

(52) U.S. Cl. CPC H01R 25/162; H01M 50/503; H01M 50/507; H01M 50/517; H01R 13/6215; H01R 13/62916; H01R 13/62922; H01R 43/26

(57) ABSTRACT

A module connector arrangement for a battery module having a cell stack which includes a plurality of battery cells arranged next to one another in a stacking direction (x), the module connector arrangement having an end plate for delimiting the end of the cell stack in the stacking direction (x), and the end plate includes an insertion opening and a receiving space accessible from outside the end plate via the insertion opening for receiving two busbar ends of a first and a second busbar to be electrically contacted over a flat surface in a receiving region of the receiving space. In particular, the module connector arrangement includes a clamping device adjacent to the receiving region and operable from outside the end plate for clampingly fastening the busbar ends received in the receiving region.

### FIELD

The invention relates to a module connector arrangement for a battery module with a cell stack comprising a plurality of battery cells arranged next to one another in a stacking direction, wherein the module connector arrangement has an end plate for delimiting the end of the cell stack in the stacking direction, and wherein the end plate comprises an insertion opening and a receiving space accessible from outside the end plate via the insertion opening for receiving two busbar ends of a first and a second busbar, which are to be electrically contacted over a large region, in a receiving region of the receiving space. Furthermore, the invention also relates to a method for fixing contact between two busbar ends by means of a module connector arrangement.

### BACKGROUND

A battery, for example a motor vehicle battery, such as a high-voltage battery, can comprise multiple battery modules. These can, for example, each have a cell stack with multiple battery cells arranged next to each other. The battery cells are electrically interconnected. The battery modules are also connected to each other via so-called module connectors. Such a module connector can not only be used to electrically connect two battery modules to each other, but also, for example, to connect a battery module or a pole terminal of the battery module to a voltage tapping point or pole terminal of the battery, i.e. a main connection of the battery. Today, modules are usually connected to each other via external module connectors. These should be protected against contact both before, during and after assembly, especially in high-voltage applications. This design usually requires additional space for the screw connections and/or contacts and the corresponding contact protection. It would therefore be desirable to be able to provide a design for such a module connector that is as space-saving and simple as possible.

EP 3 772 122 A1 describes a battery module with multifunctional end plates in which cooling connections and/or LV/HV interfaces are integrated.

Furthermore, DE 10 2021 130 443 B3 describes a high-voltage battery module with an end plate in which at least one busbar is integrated, wherein the end plate is made of an electrically insulating material. The busbar is connected to a cooling plate and the cell terminals of the cells are guided through an opening in the end plate and welded to the busbar.

Furthermore, DE 10 2018 114 764 A1 describes a pluggable module connector comprising a flexible busbar, two retaining clips and an insulation housing in which the retaining clips plugged onto the busbar can be accommodated.

In particular, contact protection can only be provided by the insulation housing after the busbar has been mounted on the cell poles, but not during assembly.

### SUMMARY

The object of the present invention is to provide a module connector arrangement and a method which allow a module connector to be designed as simply and space-efficiently as possible, for which, in particular, contact protection can be implemented as easily as possible.

The invention relates to a module connector arrangement for a battery module with a cell stack comprising a plurality of battery cells arranged next to one another in a stacking direction, has an end plate for delimiting the end of the cell stack in the stacking direction, wherein the end plate comprises an insertion opening and a receiving space accessible from outside the end plate via the insertion opening for receiving two busbar ends of a first and a second busbar, which are to be electrically contacted over a large region, in a receiving region of the receiving space. The module connector arrangement has a clamping device adjacent to the receiving region and operable from outside the end plate for fastening by clamping the busbar ends received in the receiving region.

The arrangement of the busbar ends in the receiving region and the clamping fastening of the busbar ends received in the receiving region by means of the externally actuated clamping device can thus be carried out in a time-decoupled manner. In particular, the arrangement of the busbar end of the first busbar and the busbar end of the second busbar can also take place one after the other. Thus, the busbar ends can first be arranged in the receiving region, in particular one after the other, and then fixed by the clamping device. This temporal decoupling of the arrangement of the busbar ends in the receiving region of the end plate's receiving space and of the fastening of the busbar ends allows contact protection to be implemented in a much simpler and more space-saving manner. In addition, implementing the fastening of the busbar ends as a clamping fastening is very advantageous in order to provide, on the one hand, a simple reversible detachability of this fastening and, on the other hand, to enable simple and space-saving tolerance compensation. For example, the busbars can simply be inserted into the receiving region with their ends or arranged in it and then the clamping device can be operated externally to fix the busbars to each other and within the end plate. Because the clamping device can be actuated from outside the end plate, the actuation or the actuation device provided for this purpose, for example, can be very easily electrically insulated from the voltage-bearing parts of the module connector arrangement. Thus, overall, a very simple and space-saving design of a module connector arrangement can be provided, which also enables very simple implementation of electrical insulation during assembly of the module connector arrangement.

By functionally integrating the cell and/or module contacting into the module end plates or at least one of the end plates, both touch-protected and space-optimized contacting can be achieved. Overall, this allows for a smaller installation space requirement than with conventional module contacts, good tolerance compensation, especially in the plug-in direction of the busbars, and, in addition, high pressing forces with low screw forces can be implemented using the clamping device designs explained in more detail below. In addition, the contact between the busbars can be again removed in a non-destructive manner.

The end plate can be part of a clamping device of the battery module. The cell stack can, for example, be limited on both sides by such end plates with respect to the stacking direction. The two end plates can be fastened and clamped together by a clamping device, for example tie rods and/or a clamping band and/or side plates or the like connecting the end plates to each other. This allows the cell stack to be clamped in the stacking direction using the end plates.

The end plate can be made of a plastic material or a metallic material. The end plate can, for example, be manufactured as an extruded profile or something similar. This makes it particularly easy to integrate cavities into such an end plate, at least one or more of which can then function as a receiving space for the busbars or busbar ends.

With regard to the intended arrangement of the busbar ends in the receiving space, it can be provided that only the busbar ends of one busbar are arranged in the receiving space of the end plate and thus within the end plate, or that, for example, one of the busbars is arranged completely within the end plate, while the other of the two busbars is only inserted with its busbar end into the end plate, in particular into the receiving space. If the busbar ends are accommodated in the end plate as intended, in particular arranged in the receiving region as intended, they can be clamped in place by actuating the clamping device. In other words, the clamping device can be designed such that the busbar ends are fastened exclusively by friction within the end plate and to one another.

The receiving region can represent part of the receiving space. The clamping device can also be arranged at least partially in the receiving space and directly adjacent to the receiving region. To actuate the clamping device, it can comprise an element accessible from outside the end plate or the clamping device can be actuated via a separate element accessible from outside the end plate and can itself be arranged completely within the receiving space.

The clamping device can be made of plastic or a metallic material. If the clamping device is made of plastic, it can also provide electrical insulation to the busbar ends.

A busbar end should not only be understood as the front end of such a busbar, for example a flat one, but rather as an extended end region which extends from such a busbar with respect to the longitudinal direction of the busbar. A busbar end can therefore be understood as an region of the busbar in question that includes the front end of such a busbar, but is not limited to this.

If the busbar ends are arranged as intended in the receiving region, the clamping fastening of the busbar ends can be carried out by means of the clamping device, while the clamping device or at least one element of the clamping device directly contacts or lies flat against at least one of the busbar ends, in particular a side surface of such a busbar end.

In general, the described contacting of the busbar ends by means of the module connector arrangement can be used both for contacting modules with each other and for contacting the “last” busbar, i.e. the busbar of the module to the return line, i.e. a main connection of the battery.

An end plate of a battery module, and in particular one of the busbars, can also be part of two module connector arrangements. For example, a receiving space can be provided in the end plate at two end regions of the end plate with respect to the third direction defined later, e.g. a first receiving space and a second receiving space. These can also be connected to each other through the end plate. In the first receiving space, two bar ends to be contacted with each other can be arranged, as well as a corresponding clamping device, and in the second receiving space, two bar ends to be contacted with each other, as well as a corresponding clamping device, can be arranged. It can also be provided that a bar end arranged in the first receiving space and a bar end arranged in the second receiving space represent the two busbar ends of an identical busbar, which is then arranged, for example, completely within the end plate and is guided from the first to the second receiving space through the end plate. The busbar can also be integrated into the end plate and, in particular, be electrically insulated from it. The third direction corresponds in particular to a plug-in direction in which at least one of the two bar ends can be plugged into a corresponding receiving space through the insertion opening. The second direction is preferably perpendicular to the above defined first direction.

According to a further advantageous embodiment of the invention, the clamping device is designed to reduce a dimension of the receiving region when actuated, in particular continuously, and/or to increase a clamping force on the busbar ends located in the receiving region. In particular, the clamping device can be designed for both. In particular, the increase in clamping force can be provided by reducing the dimension of the receiving region. The clamping device can, for example, be designed in such a way that when it is actuated, the receiving region is reduced somewhat, whereby the ends of the busbar are pressed together. These are essentially incompressible. If these lie flat against each other, further actuation of the clamping device no longer leads to a reduction in the dimensions of the receiving region, but, for example, only to an increase in the clamping force on the busbar ends.

In both cases, the final dimensions of the receiving region and/or the final clamping force can be continuously adjusted. This enables particularly good tolerance compensation and precise adjustment of the clamping force.

According to a further advantageous embodiment of the invention, the clamping device comprises two wedge elements which are movable relative to one another, which are movable relative to one another in particular in a first direction and are designed to reduce the receiving region in a second direction perpendicular to the first direction and/or to increase the clamping force in the second direction when moving towards one another with respect to the first direction.

A wedge element is understood to be a component that comprises at least one wedge or a wedge-shaped section. In the simplest case, the two wedge elements can be two wedges. Such a wedge or wedge-shaped section tapers in a certain direction, in particular with respect to the first direction mentioned above. Such a wedge or wedge-shaped section is formed, for example, with at least one bevel. The two wedge elements are also designed such that their respective at least one wedge or wedge-shaped section tapers in opposite directions, ie, for example, the first wedge-shaped section of the first wedge element tapers in the first direction and the second wedge-shaped section of the second wedge element widens in the first direction.

The second direction can correspond to said stacking direction.

The implementation of the clamping device with two wedge elements that can move relative to each other is particularly advantageous. These can be moved towards each other so that the clamping force to be applied can be continuously adjusted. The inclined plane of the wedges of the wedge elements creates a force perpendicular to the direction of movement of the wedge elements relative to each other, which can cause the two busbars to be clamped. By displacing two inclined planes, which can be provided by the wedge elements, against each other, the conductors to be contacted, i.e. the busbar ends, can be pressed together. The angle of these inclined planes can also be used to adjust the ratio of contact pressure to assembly or screwing force. The assembly force can be applied by screwing or pressing and then clipping or riveting.

According to a further advantageous embodiment of the invention, the module connector arrangement has an adjusting element, in particular an adjusting screw, which can be actuated from outside the end plate and by means of which the clamping device can be actuated, wherein the adjusting element is movable with respect to the first direction in order to move the first wedge element towards the second wedge element.

By means of such an adjusting element, one of the wedge elements can advantageously be moved towards the other. The adjusting element can, for example, be designed as an adjusting screw. By inserting the adjusting screw, for example, the screw end which faces the first wedge element and in particular can contact it directly or via a pressure plate can exert a corresponding pressure force on the first wedge element, whereby it is moved in the direction of the second wedge element. A thread can be integrated into the end plate into which such an adjusting screw can be screwed from outside the end plate. The corresponding counterforce can be applied via the thread. Such a thread can be provided as a separate threaded bushing integrated into the end plate as a counter bearing. In particular, as described above, the wedge elements are each designed with at least one wedge which tapers with respect to the first direction. The two wedges of the respective wedge elements taper in opposite directions. In other words, a first wedge of the first wedge element can taper in the first direction and a first wedge of the second wedge element can taper against the first direction. As the two wedge elements move towards each other, the two wedges clamp together, resulting in a clamping force perpendicular to the first direction.

According to a further advantageous embodiment of the invention, the wedge elements or the clamping device as a whole, in particular with respect to the second direction, are arranged next to the receiving region. The busbar ends arranged in the receiving region can, for example, make direct contact with one of the two wedge elements with one of their side surfaces, in particular over a large area. By clamping both wedge elements together, the corresponding pressure force can be applied to the busbar ends in the second direction.

According to a further advantageous embodiment of the invention, a first wedge element is provided in the form of a first clamp having a first base and two first legs, in particular wedge-shaped legs, projecting from the first base in the first direction, between which a first recess is provided that provides the receiving region, and a second wedge element is provided in the form of a second clamp, which comprises a second base and two second legs, in particular wedge-shaped legs, projecting from the second base counter to the first direction, between which a second recess is provided that tapers in the direction of the second base and into which a part of the first wedge element can be received, in particular in such a way that when the clamping device is actuated, this part of the first wedge element is increasingly received or can be received. The two wedge elements can therefore, for example, be provided in the form of two clamping clamps, wherein one of the two wedge elements engages into the recess of the other or can be inserted into it with increasing clamping or increasing clamping force. For example, the two busbar ends can first be inserted into the receiving region when the two clamps are not yet clamped together. One of the clamps can then be pushed towards the other, whereby the receiving region tapers, the clamps tighten, and the busbar ends are correspondingly fixedly clamped together. The receiving region is thus in a certain way framed by the two wedge elements all around. This is particularly advantageous because the wedge elements, if they are made of a plastic or other electrically insulating material, can automatically provide electrical insulation of the busbars to the end plate. Additional insulation is then not necessary. This is therefore a particularly space-saving variant.

According to a further advantageous embodiment of the invention, the clamping device comprises a rotatable clamping cam which is designed such that the clamping force can be increased and/or the receiving region can be reduced by rotating the clamping cam. Such a clamping cam can, for example, be rotatable around a rotation axis. The cross-section of such a clamping cam viewed perpendicular to the axis of rotation deviates from a circular shape. This allows the clamping cam to rotate and exert a corresponding clamping force on the busbar ends located in the receiving region. This also allows for a clamped fastening of the busbars in the end plate.

According to a further advantageous embodiment of the invention, the module connector arrangement comprises the first and the second busbar, each comprising an electrically conductive bar core and an insulation enclosing the bar core, wherein the bar cores are exposed at the busbar ends, in particular in such a way that the bar cores can be laid flat on one another and contacted. The bar cores exposed in the region of the busbar ends and the surrounding insulation can be flush with each other. This makes it particularly easy to place the two busbar ends flat on top of each other in the region of their exposed bar cores. Exposed here means that the bar cores in the region of the busbar ends are not covered by electrical insulation. This allows the busbars to be easily contacted flat with each other in the region of the busbar ends.

In addition, it can be provided that at least one of the two busbars can be inserted into the receiving space with its busbar end through the insertion opening and can be removed therefrom again. In particular, the insertion depth is dimensioned to be at least as large as the exposed bar core in the region of the busbar end. In other words, when the busbar end is arranged as intended in the receiving space, no part of the exposed bar core should be located outside the receiving space and in particular outside the end plate. As a result, at the latest when the busbar ends are arranged as intended in the receiving space, no electrically conductive part of these busbar ends can be touched. In addition, it is preferred that the bars and their corresponding electrical insulations are designed and dimensioned in such a way that the exposed bar core can be touched when one busbar end is removed from the receiving space or reaches the outer region of the end plate at the earliest when there is no longer any electrical contact between the two exposed bar cores, if the second bar is or remains arranged within the receiving space. This allows for easy, touch-protected insertion and removal of one of the two busbar ends from the receiving space.

According to a further advantageous embodiment of the invention, the receiving space is at least partially lined with electrical insulation in order to electrically insulate the exposed bar cores received in the receiving space from the end plate.

This is particularly advantageous if, for example, the clamping device as a whole is arranged next to the receiving region, i.e. the receiving region is not provided between the two clamp-shaped wedge elements. This can also provide electrical insulation to the end plate, at least if the end plate is made of a metallic material. Otherwise, such additional insulation may not be necessary.

Furthermore, the invention also relates to a battery module having a module connector arrangement according to the invention or one of its embodiments.

Furthermore, the invention also relates to a battery, in particular for a motor vehicle, having a battery module according to the invention or one of its embodiments. The battery can be designed, for example, as a high-voltage battery.

Furthermore, the invention also relates to a motor vehicle having a battery according to the invention or one of its embodiments. The motor vehicle may be designed as an electric vehicle, for example. The motor vehicle according to the invention is preferably designed as an automobile, in particular as a passenger car or truck, or as a passenger bus or motorcycle. The battery can function as a traction battery for the motor vehicle.

The invention also relates to a method for fixedly contacting two busbar ends by means of a module connector arrangement for a battery module, which comprises a cell stack comprising a plurality of battery cells arranged next to one another in a stacking direction, wherein the module connector arrangement has an end plate for delimiting the end of the cell stack in the stacking direction, and wherein the end plate comprises an insertion opening and a receiving space accessible from outside the end plate via the insertion opening for receiving two busbar ends of a first and a second busbar, which are to be electrically contacted over a large area, in a receiving region of the receiving space. It is provided that the busbar ends to be electrically contacted are arranged in the receiving region and are clamped in the receiving region by means of a clamping device adjacent to the receiving region and operable from outside the end plate, that is to say they are fastened in the receiving region in particular by clamping.

The advantages mentioned for the module connector arrangement according to the invention and its embodiments thus apply similarly to the method according to the invention.

The invention also includes refinements of the method according to the invention, which have features as have already been described in conjunction with the refinements of the module connector arrangement according to the invention. For this reason, the corresponding refinements of the method according to the invention are not described again here.

### BRIEF DESCRIPTION OF THE FIGURES

Exemplary embodiments of the invention are described hereinafter. In the figures:

FIG. 1 shows a schematic and perspective representation of a module connector arrangement according to an exemplary embodiment of the invention;

FIG. 2 shows a schematic cross-sectional representation of the module connector arrangement from FIG. 1;

FIG. 3 shows a schematic cross-sectional representation of a module connector arrangement according to another exemplary embodiment of the invention.

FIG. 4 shows a schematic cross-sectional representation of another cross-section of the module connector arrangement of FIG. 3 according to an exemplary embodiment of the invention;

FIG. 5 shows a schematic cross-sectional representation of the module connector of FIG. 4 when extracting a busbar according to an exemplary embodiment of the invention;

FIG. 6 shows a schematic representation of a part of a battery having two battery modules connected via a module connector arrangement according to an exemplary embodiment of the invention;

FIG. 7 shows a schematic cross-sectional representation of a part of a battery from FIG. 6 according to an exemplary embodiment of the invention;

FIG. 8 shows a schematic cross-sectional representation of a module connector having a clamp cam in an unclamped condition according to an exemplary embodiment of the invention; and

FIG. 9 shows a schematic cross-sectional representation of the module connector arrangement from FIG. 8 in a clamped condition according to an exemplary embodiment of the invention.

### DETAILED DESCRIPTION

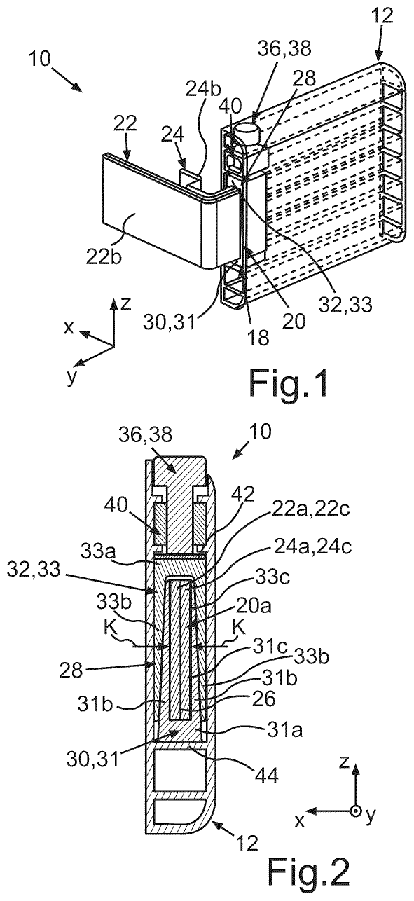

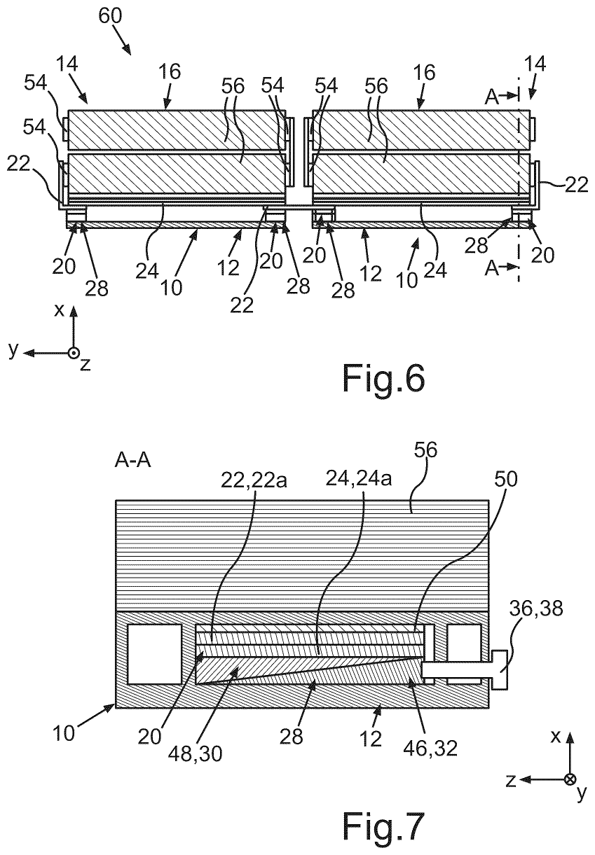

FIG. 1 shows a schematic and perspective representation of a module connector arrangement 10 according to an exemplary embodiment of the invention. This comprises an end plate 12 which, when arranged as intended in a battery module 14 (see FIG. 6), is arranged at the end of a cell stack 16 (see FIG. 6) of the battery module 14 and delimits the cell stack 16 with respect to a stacking direction which, in the present case, corresponds to the x-direction shown.

The end plate 12 can, for example, be designed as an extruded profile. The end plate 12 comprises at least one insertion opening 18 through which a receiving space 20 within the end plate 12 is accessible. In the present example, two busbars 22, 24, which can also be part of the module connector arrangement 10, are accommodated with their respective busbar ends 22a, 24a (see FIG. 2) in this receiving space 20, in particular in a receiving region 20a (see FIG. 2) of this receiving space 20. These can be inserted into the receiving space 20 in a plug-in direction that is parallel to the y-direction shown. FIG. 2 shows in particular a schematic cross-sectional view of the module connector arrangement 10 from FIG. 1 perpendicular to the y-direction. At least the regions of the busbars 22, 24 which are arranged outside the end plate 12 when the busbar ends 22a, 24a are arranged as intended in the receiving region 20a can be electrically insulated from the outside by an electrical insulation 22b, 24b. This electrical insulation 22b, 24b can enclose an electrically conductive bar core 22c, 24c. The bars 22, 24 are at least partially exposed in their end regions 22a, 24a, i.e. the corresponding bar cores 22c, 24c are not or not completely covered by the insulation 22b, 24b. As a result, a flat contact can be established between the bars 22, 24 in their end regions 22a, 24a, as can be seen in FIG. 2. These therefore each have a flat contact surface 26 which, when the busbar ends 22a, 24a are arranged as intended in the receiving region 20a, lie flat against one another.

In order to now contact the bars 22, 24 with each other or to fasten them to each other in the contacted state and to fix them in the end plate 12, a clamping device 28 which can be actuated from outside the end plate 12 is now advantageously provided. In the present example, this clamping device 28 comprises a first wedge element 30 in the form of a first clamp 31 and a second wedge element 32 in the form of a second clamp 33. The first clamp 31 has a first base 31a and two legs 31b projecting from this base 31a in the z-direction and spaced from one another in the x-direction. The second clamp 33 comprises a corresponding base 33a and two legs 33b projecting therefrom in the opposite direction to the z-direction, which are also spaced apart from each other with respect to the x-direction. A recess 31c or 33c is provided between the respective legs 31b, 33b. The first recess 31c of the first clamp 31 simultaneously also provides the receiving region 20a in which the bar ends 22a, 24a are received. The first clamp 31 including the busbar ends 22a, 24a received therein are in turn at least partially received in a second recess 33c of the second clamp 33. In particular, the two clamps 31, 33 can be moved towards each other with respect to the z-direction shown. As a result, the two clamps 31, 33 clamp or tighten each other and a clamping force K, which is illustrated in FIG. 2 by the two arrows K, can be exerted on the busbar ends 22a, 24a. The first clamp 31 can therefore be a bearing clamp 31 with two wedges 31b, e.g. made of plastic, and the second clamp 33 can be a tension clamp 33 with two wedges 33b, e.g. made of plastic.

In the present example, an adjusting element 36 movable counter to the z-direction is provided, for example in the form of an adjusting screw 38, for actuating this clamping device 28. To actuate the clamping device 28, the adjusting screw 38 can be screwed into a threaded bushing 40 accommodated in the end plate 12, which acts as a counter bearing. In addition, a distributor plate 42, in particular made of metal, can be provided between this adjusting screw 38 and the clamping device 28. As a result, the compressive force of the screw 38 can be transmitted particularly evenly and reliably to the clamping device 28, in the present example to the second clamp 33, in particular to its base. The clamp 33 can thus be moved in the direction of the first clamp 31 in the opposite direction to the z-direction by actuating or screwing in the screw 38, thereby continuously increasing the clamping force K. On the underside, the clamping device 28 can be supported by a cross strut 44 inside the end plate 12.

It would also be conceivable that the screw can be screwed in, for example, on the opposite side of the end plate 12, i.e. in the z-direction, and thereby, for example, presses the first clamp 31 in the direction of the second clamp 33 and thus increases the clamping force K.

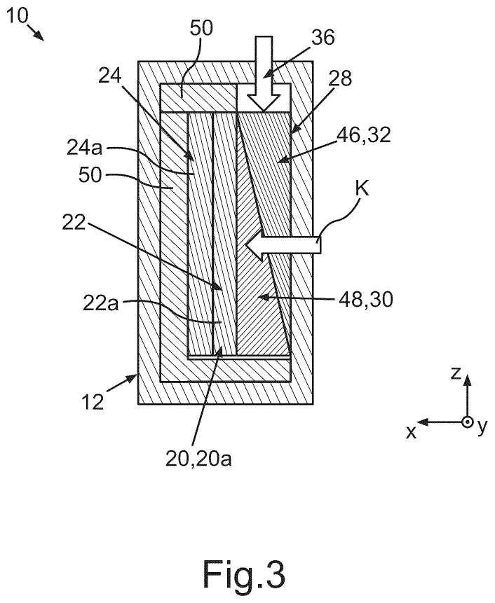

FIG. 3 shows a schematic representation of a module connector arrangement 10 according to a further exemplary embodiment of the invention. This can be designed as previously described, except that the clamping device 28 now does not comprise two clamps, but is designed with two individual wedges 46, 48, and the clamping device 28 as a whole is arranged next to the receiving region 20a of the receiving space 20 with respect to the x-direction. However, the operating principle is analogous to that described previously. By means of an adjusting element 36, which is illustrated here only by an arrow, the two wedges 46, 48 can be moved towards one another, in particular in the present example the wedge 46 can be moved towards the wedge 48 in the opposite direction to the z-direction, whereby a clamping force K is generated perpendicular to the z-direction, in particular in the x-direction, whereby in turn the two busbar ends 22a, 24a are pressed against one another and are thereby clamped in place. The two busbars 22, 24 are connected to each other via two wedges 46, 48. The inclined plane creates a force K perpendicular to the screw direction and thus tensions the two busbars 22, 24. In the present example, the receiving space 20 is also partially covered with electrical insulation 50. The exposed bar cores 22c, 24c of the busbar ends 22a, 24a can be or are electrically insulated from the end plate 12 via this insulation 50.

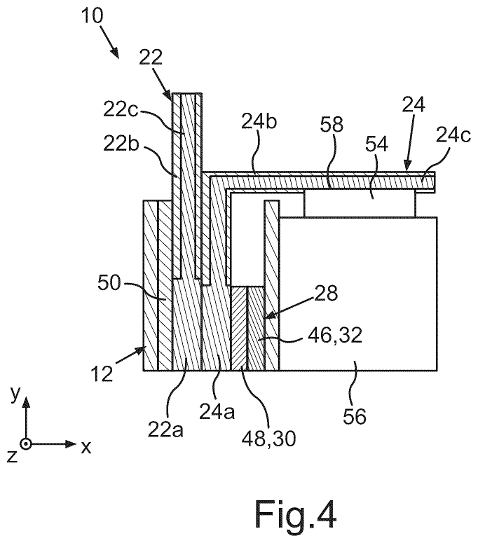

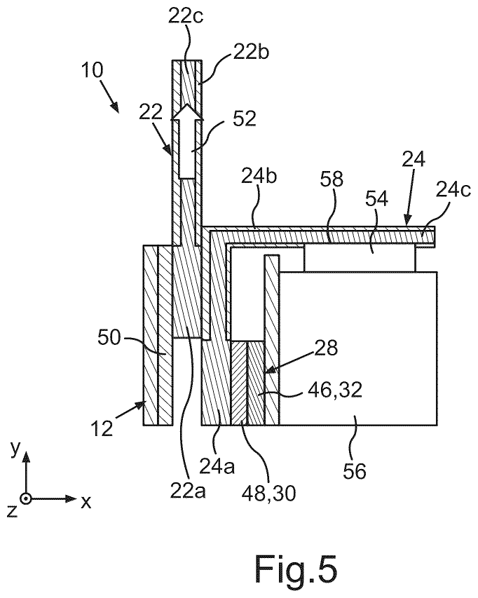

FIG. 4 and FIG. 5 each show the module connector arrangement 10 from FIG. 3 in a different cross-section, namely perpendicular to the z-direction shown. FIG. 4 shows the module connector arrangement 10 in a state in which the two busbar ends 22a, 24a are received as intended in the receiving region 20a and clamped or tightened together, and FIG. 5 shows a state of the module connector arrangement 10 in which one of the bars 22 is removed from the receiving space 20. The removal is illustrated by arrow 52. The other of the two bars 24 is also electrically connected to a cell pole 54 of a battery cell 56 of the cell stack 16. For this purpose, the bar 24 can be designed without insulation 24b in a further surface region 58.

As can be seen in particular in FIG. 5, the insulations 22b, 24b of the bars 22, 24 are designed such that when one of the bars, in this case the bar 22, is removed from the receiving region 20a, the electrically conductive contact between the two busbar ends 22a, 24a is interrupted before the exposed bar core 22c of the end region 22a of the bar 22 leaves the receiving space 20 and can thus be touched. In other words, this design of the insulation 22b, 24b of the busbars 22, 24 permanently provides reliable protection against contact during assembly and disassembly. After loosening the wedge connection or clamping device 28, each busbar 22, 24 is protected against contact and only loses the contact protection when pulled out. The contact, in particular between the busbars 22, 24, is already eliminated.

FIG. 6 shows a schematic representation of a part of a battery 60 with two battery modules 14, each of which can comprise a corresponding cell stack 16 with multiple battery cells 56 arranged next to one another in the stacking direction x. The modules 14 each have a module connector arrangement 10, via which the two modules 14 are electrically connected to one another. In this case, parts of one module connector arrangement can also be regarded as part of the other module connector arrangement, e.g. the busbar 22, which is arranged with its ends in both receiving spaces 20 of the two end plates 12.

As can be seen here, a respective end plate 12 can, for example, be formed with two opposite receiving spaces 20, in each of which two busbar ends of two busbars to be contacted are received. The receiving spaces 20 can also be designed as a continuous unit. One of these busbars, in this case the busbar 24, can be passed through the entire end plate 12 within it in the y-direction. The end plate 12 can be designed with corresponding clamping devices 28 on both opposite sides in the y direction. Due to the design of these module connector arrangements 10, the modules 14 can be arranged very close to one another, especially in the y-direction shown.

FIG. 7 shows again a schematic cross-sectional representation of a cross section along the section line A-A as shown in FIG. 6. In particular, the adjusting screw 38 for actuating the clamping device 28 is also shown here.

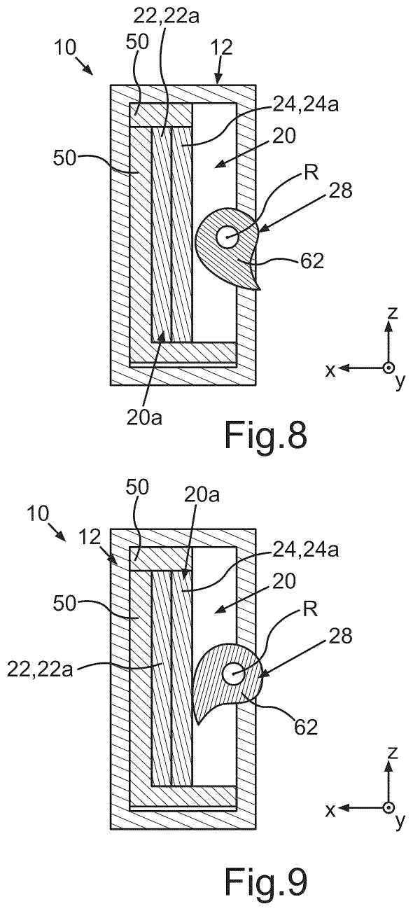

FIG. 8 shows a schematic cross-sectional representation of a module connector arrangement 10 according to another exemplary embodiment of the invention. This can be designed as previously described, except for the difference that the clamping device 28 is not implemented by wedge elements in the present case, but by means of a clamping cam 62 which is rotatable about a rotation axis R and which can also be called a clamping cam, for example. FIG. 8 shows the cam 62 in a non-tensioned state and FIG. 9 in the tensioned state or in a state that tightens the busbar ends 22a, 24a.

Overall, examples show how the invention can provide a touch-protected, detachable cell or module connector. By functionally integrating the cell/module contact into the module end plates, both touch-protected and space-optimized contacting can be achieved. By moving two inclined planes or wedges against each other, the conductors to be contacted are pressed together. The angle can be used to adjust the ratio of pressing force to assembly or screwing force. The assembly force can be applied by screwing or pressing and then clipping or riveting. The described contacting can be used both for contacting modules with each other and for contacting the “last” busbar to the return line. The advantages are a smaller installation space requirement than with conventional module contacts, good tolerance compensation in the plug-in direction of the busbars, the inclined plane allows high contact forces to be implemented with low screw forces and the contact can be removed again without causing any damage.

1. A module connector arrangement for a battery module having a cell stack, which comprises multiple battery cells arranged next to one another in a stack direction (x),
wherein the module connector arrangement has an end plate for the end limitation of the cell stack in the stacking direction (x),
wherein the end plate comprises an insertion opening and a receiving space accessible via the insertion opening from outside the end plate for receiving two busbar ends of a first and a second busbar to be electrically contacted in a receiving region of the receiving space,
wherein the module connector arrangement comprises a clamping device adjacent to the receiving region and operable from outside the end plate for clampingly fastening the busbar ends received in the receiving region.

2. The module connector arrangement according to claim 1, wherein the clamping device is designed to reduce a dimension of the receiving region upon actuation, in particular continuously, and/or to increase a clamping force (K) on the busbar ends located in the receiving region.

3. The module connector arrangement according to claim 1, wherein the clamping device comprises two wedge elements which are movable relative to one another, which are movable relative to one another in particular in a first direction (z) and are designed to reduce the receiving region in a second direction (x) perpendicular to the first direction (z) and/or to increase the clamping force (K) in the second direction (x) when moving towards one another with respect to the first direction (z).

4. The module connector arrangement according to claim 1, wherein the module connector arrangement has an adjusting element, in particular an adjusting screw, which can be actuated from outside the end plate and by means of which the clamping device can be actuated, wherein the adjusting element is movable with respect to the first direction (z) in order to move a first wedge element towards the second wedge element.

5. The module connector arrangement according to claim 1, wherein the wedge elements or the clamping device as a whole, in particular with respect to the second direction (x), are arranged next to the receiving region.

6. The module connector arrangement according to claim 1, wherein a first wedge element in the form of a first clamp with a first base and two first legs projecting from the first base in the first direction (z), between which a first recess is provided which provides the receiving region, and a second wedge element in the form of a second clamp is provided, which comprises a second base and two second legs projecting from the second base counter to the first direction (z), between which a second recess tapering in the direction (z) of the second base is provided, into which a part of the first wedge element can be received and is increasingly received, in particular upon actuation of the clamping device.

7. The module connector arrangement according to claim 1, wherein the clamping device comprises a rotatable clamping cam which is designed such that the clamping force (K) can be increased and/or the receiving region can be reduced in size by rotating the clamping cam.

8. The module connector arrangement according to claim 1, wherein the module connector arrangement comprises the first and the second busbar, each comprising an electrically conductive bar core and an insulation enclosing the bar core, wherein the bar cores are exposed at the busbar ends, in particular such that the bar cores can be laid flat on one another and contacted.

9. The module connector arrangement according to claim 1, wherein the receiving space is at least partially lined with an electrical insulation in order to electrically insulate the exposed bar cores received in the receiving space from the end plate.

10. A method for fixing contact between two busbar ends by a module connector arrangement for a battery module comprising a cell stack with a plurality of battery cells arranged next to one another in a stacking direction (x),
wherein the module connector arrangement has an end plate for the end limitation of the cell stack in the stacking direction (x),
wherein the end plate comprises an insertion opening and a receiving space accessible via the insertion opening from outside the end plate for receiving two busbar ends of a first and a second busbar to be electrically contacted over a flat surface in a receiving region of the receiving space,
wherein the busbar ends to be electrically contacted are arranged in the receiving region, and
are clamped in the receiving region by means of a clamping device adjacent to the receiving region and actuated from outside the end plate.

11. The module connector arrangement according to claim 2, wherein the clamping device comprises two wedge elements which are movable relative to one another, which are movable relative to one another in particular in a first direction (z) and are designed to reduce the receiving region in a second direction (x) perpendicular to the first direction (z) and/or to increase the clamping force (K) in the second direction (x) when moving towards one another with respect to the first direction (z).

12. The module connector arrangement according to claim 2, wherein the module connector arrangement has an adjusting element, in particular an adjusting screw, which can be actuated from outside the end plate and by means of which the clamping device can be actuated, wherein the adjusting element is movable with respect to the first direction (z) in order to move a first wedge element towards the second wedge element.

13. The module connector arrangement according to claim 3, wherein the module connector arrangement has an adjusting element, in particular an adjusting screw, which can be actuated from outside the end plate and by means of which the clamping device can be actuated, wherein the adjusting element is movable with respect to the first direction (z) in order to move a first wedge element towards the second wedge element.

14. The module connector arrangement according to claim 2, wherein the wedge elements or the clamping device as a whole, in particular with respect to the second direction (x), are arranged next to the receiving region.

15. The module connector arrangement according to claim 3, wherein the wedge elements or the clamping device as a whole, in particular with respect to the second direction (x), are arranged next to the receiving region.

16. The module connector arrangement according to claim 4, wherein the wedge elements or the clamping device as a whole, in particular with respect to the second direction (x), are arranged next to the receiving region.

17. The module connector arrangement according to claim 2, wherein a first wedge element in the form of a first clamp with a first base and two first legs projecting from the first base in the first direction (z), between which a first recess is provided which provides the receiving region, and a second wedge element in the form of a second clamp is provided, which comprises a second base and two second legs projecting from the second base counter to the first direction (z), between which a second recess tapering in the direction (z) of the second base is provided, into which a part of the first wedge element can be received and is increasingly received, in particular upon actuation of the clamping device.

18. The module connector arrangement according to claim 3, wherein a first wedge element in the form of a first clamp with a first base (and two first legs projecting from the first base in the first direction (z), between which a first recess is provided which provides the receiving region, and a second wedge element in the form of a second clamp is provided, which comprises a second base and two second legs projecting from the second base counter to the first direction (z), between which a second recess tapering in the direction (z) of the second base is provided, into which a part of the first wedge element can be received and is increasingly received, in particular upon actuation of the clamping device.

19. The module connector arrangement according to claim 4, wherein a first wedge element in the form of a first clamp with a first base and two first legs projecting from the first base in the first direction (z), between which a first recess is provided which provides the receiving region, and a second wedge element in the form of a second clamp is provided, which comprises a second base and two second legs projecting from the second base counter to the first direction (z), between which a second recess tapering in the direction (z) of the second base is provided, into which a part of the first wedge element can be received and is increasingly received, in particular upon actuation of the clamping device.

20. The module connector arrangement according to claim 5, wherein a first wedge element in the form of a first clamp with a first base and two first legs projecting from the first base in the first direction (z), between which a first recess is provided which provides the receiving region, and a second wedge element in the form of a second clamp is provided, which comprises a second base and two second legs projecting from the second base counter to the first direction (z), between which a second recess tapering in the direction (z) of the second base is provided, into which a part of the first wedge element can be received and is increasingly received, in particular upon actuation of the clamping device.
